(19) United States
(12) Patent Application Publication
(10) Pub. No.: US 2011/0079333 A1
(43) Pub. Date: Apr. 7, 2011

(54) MULTI-LEVEL TIRE TREADWEAR INDICATOR

(76) Inventors: Jacques Collette, Bastogne (BE); Daniel Scheuren, Arlon (BE); Gregory William Camarato, North Royalton, OH (US); Qingye Yin, Dalian (CN); Jacques Rene Smeets, Eischen (LU)

(21) Appl. No.: 12/574,105

(22) Filed: Oct. 6, 2009

(51) Int. Cl. B60C 11/24

(52) U.S. Cl. 152/154.2; 152/209.22

(57) ABSTRACT

A tire tread includes at least one tread element and a treadwear indicator. The tread element projects from a base of the tire tread. The tread element has a radially outermost surface for contacting a road surface. The treadwear indicator includes a first step and a second step radially offset from the first step. The first step has a first surface disposed radially inward of the outermost surface of the tread element. The second step is disposed radially inward of the outermost surface of the tread element.

### FIELD OF THE INVENTION

The present invention is directed to a tire tread, and more specifically, to a tire tread with a treadwear indicator.

### BACKGROUND OF THE INVENTION

The use of treadwear indicators is not new and the use of treadwear indicators is mandated by law in many countries. A variety of such indicators are known. Once such type employs colored means, such as colored rubber or colored fibers, below the tread for a visual indicator of wear. Other types use tie-bar type elements in the tread grooves. Under US law, the upper surface of a treadwear indicator must be located at a height of 1/16″ (1.6 mm) from the base of a groove in which the treadwear indicator is located.

A practical problem with the colored indicators is that there is no way for the operator to determine the level of wear until the tire is worn. When the tire employs the tie-bar type wear indicator, since the treadwear indicator is the same color as the remaining part of the tread, it can be difficult to determine the level of wear. Another practical problem is that a treadwear indicator constructed at one height for one country's requirements may not meet the standard heights required by other countries. Thus, a different construction may be required for each different country, leading to manufacturing and other assorted organizational costs.

### SUMMARY OF THE INVENTION

A tire tread in accordance with the present invention includes at least one tread element and a treadwear indicator. The tread element projects from a base of the tire tread. The tread element has a radially outermost surface for contacting a road surface. The treadwear indicator includes a first step and a second step radially offset from the first step. The first step has a first surface which is disposed radially inward of the outermost surface of the tread element. The second step is disposed radially inward of the outermost surface of the tread element.

According to another aspect of the present invention, the second step is disposed radially inward from the first step and the outermost surface of the tread element.

According to still another aspect of the present invention, the first and second steps define planes generally parallel with the outermost surface of the tread element.

According to yet another aspect of the present invention, the first step includes an insignia and the second step includes an insignia for informing an operator that the wear condition of the tire tread is acceptable.

According to still another aspect of the present invention, the first step is rectangular.

According to yet another aspect of the present invention, the first step is circular.

According to still another aspect of the present invention, the first step is rectangular and the second step is circular.

According to yet another aspect of the present invention, the first step is circular and defines a recess radially inward from the second step.

According to still another aspect of the present invention, the second step is circular and extends radially away from the second step.

According to yet another aspect of the present invention, the second step is rectangular.

A treadwear indicator in accordance with the present invention includes a first step and a second step radially offset from the first step. The first step has a first surface disposed radially inward of an outermost surface of a road contacting tread element. The second step is disposed radially inward of the outermost surface of the road contacting tread element.

According to another aspect of the present invention, the second step is disposed radially inward from the first step and the outermost surface of the road contacting tread element.

According to still another aspect of the present invention, the first and second steps define planes generally parallel with the outermost surface of the road contacting tread element.

According to yet another aspect of the present invention, the first step includes an insignia and the second step includes an insignia for informing an operator that the wear condition of the tire tread is acceptable.

According to still another aspect of the present invention, the first step is rectangular.

According to yet another aspect of the present invention, the first step is circular.

According to still another aspect of the present invention, the first step is rectangular and the second step is circular.

According to yet another aspect of the present invention, the first step is circular and defines a recess radially inward from the second step.

According to still another aspect of the present invention, the second step is circular and extends radially away from the second step and the first step is rectangular.

### Definitions

The following definitions are applicable to the present invention.

“Annular” means formed like a ring.

“Axial” and “axially” are used herein to mean lines or directions that are parallel to the axis of rotation of the tire.

“Circumferential” means lines or directions extending along the perimeter of the surface of the annular tire parallel to the Equatorial Plane (EP) and perpendicular to the axial direction.

“Groove” means an elongated void area in a tread that may extend circumferentially or laterally about the tread in a straight curved, or zigzag manner. Circumferentially and laterally extending grooves sometimes have common portions and may be sub classified as “wide”, “narrow”, or “slot”. The slot typically is formed by steel blades inserted into a cast or machined mold or tread ring therefor. In the appended drawings, slots are illustrated by single lines because they are so narrow. A “slot” is a groove having a width in the range from about 0.2% to 0.8% of the compensated tread width, whereas a “narrow groove” has a width in the range from about 0.8% to 3% of the compensated tread width and a “wide groove” has a width greater than 3% thereof. The “groove width” is equal to tread surface area occupied by a groove or groove portion, the width of which is in question, divided by the length of such groove or groove portion; thus, the groove width is its average width over its length. Grooves, as well as other voids, reduce the stiffness of tread regions in which they are located. Slots often are used for this purpose, as are laterally extending narrow or wide grooves. Grooves may be of varying depths in a tire. The depth of a groove may vary around the circumference of the tread, or the depth of one groove may be constant but vary from the depth of another groove in the tire. If such narrow or wide groove are of substantially reduced depth as compared to wide circumferential grooves which they interconnect, they are regarded as forming “tie bars” tending to maintain a rib-like character in the tread region involved.

“Inner” means toward the inside of the tire and “outer” means toward its exterior.

“Lateral” means an axial direction.

“Leading” means a portion or part of the tread that contacts the ground first, with respect to a series of such parts or portions, during rotation of the tire in the direction of travel.

“Lugs” means discontinuous radial rows of tread rubber in direct contact with the road surface.

“NSK” means non-skid depth of a tread (i.e., the radially innermost, outer surface usually at the base of the grooves).

“Outer” means toward the tire's exterior.

“Radial” and “radially” are used to mean directions radially toward or away from the axis of rotation of the tire.

“Rib” means a circumferentially extending strip of rubber on the tread which is defined by at least one circumferential “wide groove” and either a second such groove or a lateral edge of the tread, the strip of rubber being laterally undivided by full-depth narrow or wide grooves.

“Tie-Bar” means an extra thickness of rubber at the bottom of a slot such that, in the location where the extra rubber is present, the slot depth is less than the slot depth at all other locations. Tie-bars stabilize a lug by limiting the independent movement of two portions of a lug that are separated by slots, while traction properties that are inherent in the use of slots are provided.

“Trailing” means a portion or part of the tread that contacts the ground last, with respect to a series of such parts or portions during rotation of the tire in the preferred direction of travel.

“Tread” means a molded rubber component which, when bonded to a tire casing, includes that portion of the tire that comes into contact with the road when the tire is normally inflated and under normal load.

### BRIEF DESCRIPTION OF THE DRAWINGS

The invention will be described by way of example and with reference to the accompanying drawings in which:

FIG. 1 schematically illustrates a portion of a ribbed tire tread in accordance with the present invention;

FIG. 2 schematically illustrates a detail of a treadwear indicator in accordance with the present invention;

FIG. 3 schematically illustrates a portion of a block tire tread in accordance with the present invention;

FIG. 4 schematically illustrates a detail of a treadwear indicator in accordance with another aspect of the present invention; and

FIG. 5 schematically illustrates a detail of a treadwear indicator in accordance with still another aspect of the present invention.

### DETAILED DESCRIPTION OF EXAMPLES OF THE PRESENT INVENTION

The following language is of the best presently contemplated mode or modes of carrying out the invention. This description is made for the purpose of illustrating the general principals of the invention and should not be taken in a limiting sense. The scope of the invention is best determined by reference to the appended claims.

Commercial tires must comply with local regulations in place in their destination countries. In general, there are two major treadwear indicator (TWI) standards which are incompatible. First, the DOT standard of USA requires a TWI height above NSK of 1/16″ with a tolerance of (+ 1/64″, −0″). In mm, this is a TWI at a height above NSK of between 1.59 mm and 1.98 mm. Second, the CCC standard of China requires a TWI height above NSK of at least 2.0 mm. Therefore, conventional TWIs cannot economically meet both standards with a single mold design.

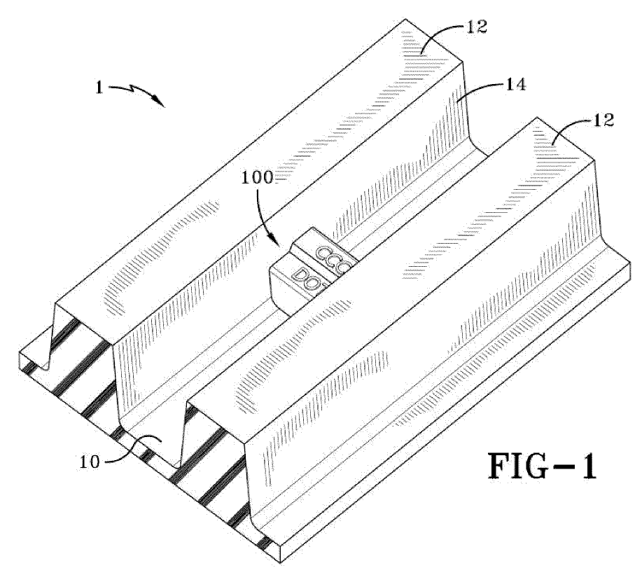

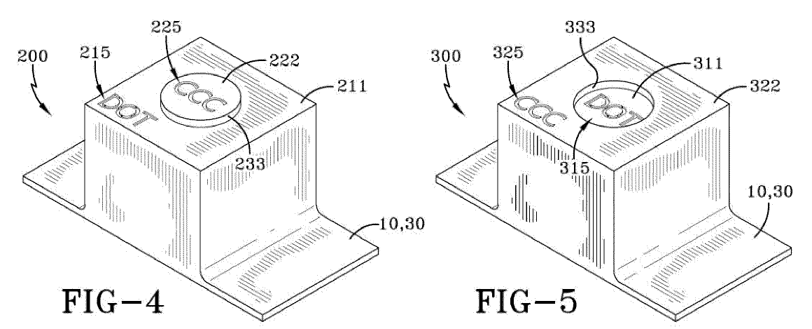

A TWI in accordance with the present invention may include multiple levels, each one being in compliance with a different specific standard. As an example, current demand typically requires a TWI in compliance with DOT and CCC standards. However, in accordance with the present invention, the TWI may be expanded to additional standards, such as GCC (India-Indonesia), etc. Further, in accordance with the present invention, different shapes may be used to show a second (and third, fourth, . . . ) level of treadwear. The example TWI of FIGS. 1-3 shows one example having a rectangular stepped configuration around the middle of the TWI, this step forming an angle of 90 deg versus the tire circumference. The example TWIs of FIGS. 4-5 show a circular step/recess extending from a rectangular step.

As an alternative feature, the name of each standard may be engraved/molded on outer surface of each corresponding step of the TWI. As shown, but not limited in the FIGS., one step may correspond to DOT and another step to CCC. Consequently, the multi-level TWI in accordance with the present invention may allow sale and use of a single tire for different markets, where the laws do not permit overlap in the TWI heights. Further, the use of the same molds, rather than separate molds, for multiple markets/regions may be permitted. Additionally, warehousing of the tires, production planning, and other commercial aspects may be enhanced, as well as costs minimized.

Conventional TWIs mainly offer gimmicks aimed to provide more information to a user regarding the remaining height of the design. However, these do not allow a single tire to comply with multiple regulatory requirements.

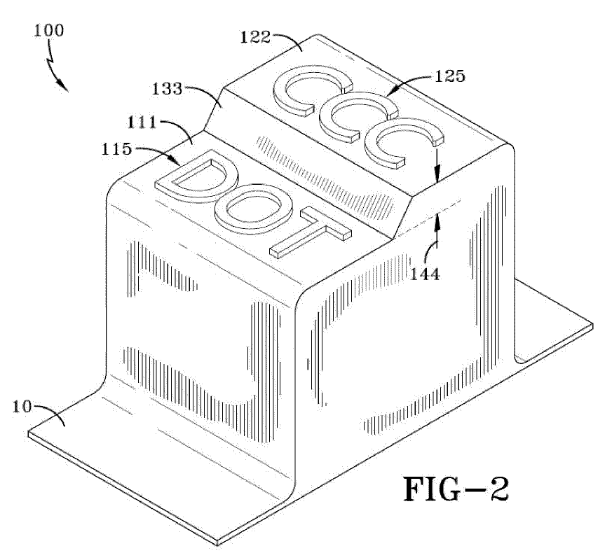

A portion of an example tire tread 1 for use with the TWI 100 of the present invention is illustrated in FIGS. 1-2. The example tread 1 is characterized by at least one circumferentially extending groove 10 and adjacent ribs 12. Each rib 12 may have at least one radially extending sidewall 14 facing the circumferential groove 10 and a radially outermost surface for contacting a road surface. Those skilled in the art will appreciate that the tire tread may have more than one circumferential groove 10 and multiple continuous or non-continuous ribs 12.

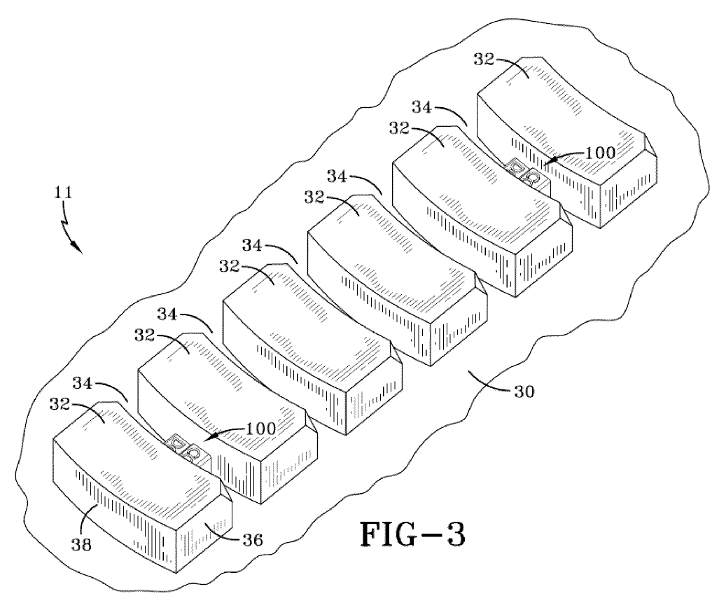

Located within the groove 10 is at least one treadwear indicator 100 in accordance with the present invention. As shown in the detail of FIG. 3, the TWI 100 includes a first rectangular step 111 and a second, radially outer rectangular step 122 with a radially extending transition portion 133 interconnecting the steps. The first and second steps 111, 122 may be generally parallel with the outermost surface of the rib(s) 12. Utilizing the DOT and CCC standards discussed above, the radial offset 144 of the steps 111, 122 may be between 0.41 mm and 0.02 mm. The first step 111 may further include a DOT insignia 115 and the second step 122 may include a CCC insignia 125.

When the example tire 1 is unworn, the steps 111, 122 both clearly show the undamaged insignias 115, 125 and may inform the operator that the wear condition of the tread 1 is acceptable according to DOT and CCC standards. As the tread 1 wears, the radially outer second step 122 will eventually reach the same radial level as the worn outer surface of the ribs 12. At this time, the CCC insignia 125 will also be worn away so that it will be clear that the tread 1 has reached its wear limit according to the CCC standard. If the tread 1 is being utilized in a CCC jurisdiction, the tire has reached the limit of its use and should no longer be used. If the tread 1 is being utilized in a DOT jurisdiction, this is of no account and the tire may continue to be used.

As the tread 1 wears further, the radially inner first step 111 will eventually reach the same radial level as the more worn outer surface of the ribs 12. At this time, the DOT insignia 115 will also be worn away so that it will be clear that the tread 1 has reached its wear limit according to the DOT standard. If the tread 1 is being utilized in a DOT jurisdiction, the tire has reached the limit of its use and should no longer be used. Thus, a single tire with a TWI 100 in accordance with the present invention may be used in either a DOT or a CCC jurisdiction while complying with both standards simultaneously.

FIG. 3 shows another example embodiment employing the TWI 100. A portion of a tread 11 is shown, the tread having a plurality of blocks 32. The blocks 32 are delineated by circumferential grooves 30, similar to the circumferential groove 10 of FIG. 1, and lateral grooves 34. The blocks 32 have radially extending sidewalls 36, 38. Two TWIs 100 may be located within two of the lateral grooves 34. The TWIs 100 may also be located in adjacent lateral grooves 34.

FIG. 4 shows a detail of another embodiment of a TWI 200 in accordance with the present invention for use with the example treads 1, 11. The TWI 200 includes a first rectangular step 211 and a second, radially outer circular step 222 with a radially extending cylindrical transition portion 233 interconnecting the steps. Utilizing the DOT and CCC standards discussed above, the radial offset of the steps 211, 222 may be between 0.41 mm and 0.02 mm. The first step 211 may further include a DOT insignia 215 and the second step 222 may include a CCC insignia 225. As the tread 1 or 11 wears, the TWI 200 functions in a similar manner as the TWI 100.

FIG. 5 shows a detail of still another embodiment of a TWI 300 in accordance with the present invention for use with the example treads 1, 11. The TWI 300 includes a first circular step 311 and a second, radially outer rectangular step 322 defining a cylindrical transition portion 333 interconnecting the steps. Utilizing the DOT and CCC standards discussed above, the radial offset of the steps 311, 322 may be between 0.41 mm and 0.02 mm. The first step 311 may further include a DOT insignia 315 and the second step 322 may include a CCC insignia 325. As the tread 1 or 11 wears, the TWI 300 functions in a similar manner as the TWI 100 or 200.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire tread for a vehicle tire, the tread comprising:
at least one tread element projecting from a base of the tire tread, the at least one tread element having a radially outermost surface for contacting a road surface; and
a treadwear indicator including a first step and a second step radially offset from the first step, the first step having a first surface disposed radially inward of the outermost surface of the at least one tread element, the second step disposed radially inward of the outermost surface of the at least one tread element.

2. The tire tread as set forth in claim 1 wherein the second step is disposed radially inward from the first step and the outermost surface of the at least one tread element.

3. The tire tread as set forth in claim 1 wherein the first and second steps define planes generally parallel with the outermost surface of the at least one tread element.

4. The tire tread as set forth in claim 1 wherein the first step includes an insignia and the second step includes an insignia for informing an operator that the wear condition of the tire tread is acceptable.

5. The tire tread as set forth in claim 1 wherein the first step is rectangular.

6. The tire tread as set forth in claim 1 wherein the first step is circular.

7. The tire tread as set forth in claim 1 wherein the first step is rectangular and the second step is circular.

8. The tire tread as set forth in claim 1 wherein the first step is circular and defines a recess radially inward from the second step.

9. The tire tread as set forth in claim 1 wherein the second step is circular and extends radially away from the second step.

10. The tire tread as set forth in claim 9 wherein the first step is rectangular.

11. A treadwear indicator comprising:
a first step; and
a second step radially offset from the first step, the first step having a first surface disposed radially inward of an outermost surface of a road contacting tread element, the second step disposed radially inward of the outermost surface of the road contacting tread element.

12. The treadwear indicator as set forth in claim 11 wherein the second step is disposed radially inward from the first step and the outermost surface of the road contacting tread element.

13. The treadwear indicator as set forth in claim 12 wherein the first and second steps define planes generally parallel with the outermost surface of the road contacting tread element.

14. The treadwear indicator as set forth in claim 13 wherein the first step includes an insignia and the second step includes an insignia for informing an operator that the wear condition of the tire tread is acceptable.

15. The treadwear indicator as set forth in claim 14 wherein the first step is rectangular.

16. The treadwear indicator as set forth in claim 14 wherein the first step is circular.

17. The treadwear indicator as set forth in claim 14 wherein the first step is rectangular and the second step is circular.

18. The treadwear indicator as set forth in claim 14 wherein the first step is circular and defines a recess radially inward from the second step.

19. The treadwear indicator as set forth in claim 14 wherein the second step is circular and extends radially away from the second step.

20. The treadwear indicator as set forth in claim 9 wherein the first step is rectangular.
